(19) United States
(12) Patent Application Publication
(10) Pub. No.: US 2008/0045442 A1
(43) Pub. Date: Feb. 21, 2008

(54) Cleaning compositions comprising surfactant boosting polymers

(76) Inventors: Eva Schneiderman, Mason, OH (US); David Thomas Stanton, Hamilton, OH (US); Randall Thomas Reilman, Cincinnati, OH (US); Christopher James Binski, Liberty Township, OH (US); Julie Ann Menkhaus, Cleves, OH (US); Jeffrey John Scheibel, Loveland, OH (US); Pramod Kakumanu Reddy, Heidelberg (DE); Rafael Ortiz, Milford, OH (US); Jodi Lee Brown, Cincinnati, OH (US); Shankang Zhou, Beijing (CN); Randall Alan Watson, Beijing (CN)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/894,842

(22) Filed: Aug. 22, 2007

Related U.S. Application Data
(62) Division of application No. 11/015,378, filed on Dec. 17, 2004.
(60) Provisional application No. 60/531,225, filed on Dec. 19, 2003.

(51) Int. Cl. C11D 1/00

(52) U.S. Cl. 510/535

(57) ABSTRACT

A method of identifying, selecting, and designing polymers that give surfactant boosting properties in the presence of free ion hardness. Such methods also result in increased cleaning when used in a cleaning composition.

### CROSS REFERENCE TO RELATED APPLICATION

This application is a Divisional Application of U.S. application Ser. No. 11/015,378, filed Dec. 17, 2004, which claims benefit under 35 U.S.C. § 119(e) to U.S. provisional application No. 60/531,225, filed Dec. 19, 2003.

### FIELD OF THE INVENTION

This invention relates to a polymer and surfactant composite such that the composite, when in the presence of free ion hardness exhibits an SB₅₀ value of 430 or less, giving an increased amount of surfactant available compared to the surfactant alone in the presence of free ion hardness and improved cleaning.

### BACKGROUND OF THE INVENTION

Cleaning conditions often dictate the choice of a surfactant in cleaning compositions. Anionic surfactants, known for good cleaning performance under soft water conditions, however, are notoriously known to aggregate under conditions with free hardness. Free hardness such as free calcium or other multiply charged metal cations, in the presence of anionic surfactants often result in the formation of higher ordered aggregates (such as vesicles and crystals) as the anionic surfactant combines with the free hardness. This results in loss of available anionic surfactant for cleaning.

There are several known approaches as to how a formulator may make anionic surfactant system hardness tolerant when used in the presence of free hardness. Modifications to anionic surfactant via ethoxylation and/or introduction of a mid-chain branch in the molecule, the use of builders, and co-surfactant usage address the formation of higher ordered aggregates. Despite these approaches, it still remains an unsolved problem to effectively prevent the formation of higher ordered aggregates when utilizing anionic surfactants in the presence of free hardness.

It is known for cleaning compositions to contain mixture of surfactants and polymers. Polymers have multiple uses in cleaning compositions, such as soils suspension agents, soil release agents, viscosity modifiers, structurants, gelling agents, coacervate formers and rheology controls agents, among other uses. Depending on the application, polymers structures have been designed either to minimize interaction with other formula ingredients, and/or maximize interaction (e.g. to achieve formation of coacervates).

It is also known that the formation of “surfactant-polymer” complex may provide desired cleaning benefits (patent #WO 01/79408 A1). However at the same time it is strictly mentioned that efficient control of free calcium is key in achieving cleaning benefits.

However it still remains an unsolved problem to have effective cleaning from a polymer in the presence of at least one surfactant and free ion (i.e., Ca²⁺ and Mg²⁺) hardness.

### SUMMARY OF THE INVENTION

The present invention relates to a polymer characterized by comprising solubility of at least 10 ppm at 20° C., a weight average molecular weight from about 1500 to 200,000 daltons; and further comprising a main chain and at least one side chain extending from the main chain; the side chain comprising an alkoxy moiety and the side chain comprising a terminal end such that the terminal end terminates the side chain. The polymer, when placed in contact with at least one surfactant, has an SB₅₀ value of 430 or less when in the presence of the water having at least 2 gpg free ions.

The present invention further relates to a method of preventing large ordered aggregates and the level of available surfactant of at least one surfactant comprising the use of a minimum molar amount of a surfactant boosting polymer.

The present invention further relates to a method of selecting and designing a polymer for use in the presence of at least one surfactant wherein the method comprises the steps of

(a) calculating:
log(1/SB₅₀)=−2.150+0.903*CD₂+0.227*COPC−0.792*CD₆+0.123*ESO_{4+0.007*}SH_{Bint10}+0.112*dxvp5 Correlation (I)
(b) selecting an appropriate polymer based upon the calculation of Correlation (I)

The present also relates to a cleaning composition comprising from about 0.1% to about 20% by weight of the cleaning composition of an anionic surfactant; and from about 0.001% to about 30% by weight of the cleaning composition of a surfactant boosting polymer, the polymer being selected from the group of consisting of polyimine polymers, alkoxylated monoamines, branched polyaminoamines, modified polyol ethoxylated polymers, and hydrophobic polyamine ethoxylate polymers.

### DETAILED DESCRIPTION OF THE INVENTION

It has been surprisingly discovered by the present invention that free ion hardness, such as calcium in ionic form, is not detrimental to cleaning performance of polymer and surfactant composite when the correct polymer is chosen. It has been also been discovered by the present invention that surfactant-polymer complexes are very beneficial in providing cleaning benefits. Without being bound by a theory, it is believed that mere strength of the interaction between the surfactant and polymer does not necessary correlate with observable cleaning benefits with or without the presence of free hardness.

The present invention relates to polymers which when used in combination with surfactants prevent formation and growth of large surfactant aggregates, such as those of uni- and multilayered vesicles, crystals, and liquid crystals. Such polymers are referred to herein as “surfactant boosting” polymers. The present invention addresses the problem of surfactant hardness sensitivity through the use of surfactant boosting polymers, preferably cationic and/or zwitterionic polymers. However, neutral and anionically charged polymers have been identified as possessing this property. The present invention further relates to a method of selecting a surfactant boosting polymer through QSAR methodology similar to that as disclosed in patent WO 02/044686

Surfactant Boosting Polymer

The polymer of the present invention comprises a main chain and at least one side chain having a terminal end extending from the main chain. The terminal end of the side chain terminates the side chain. The main chain may be a group of atoms, functional group, straight and/or branched group, it may be a homological or a heterological (copolymeric) in nature. The main chain, generally known as the backbone or core, may in some polymer structures be difficult or impossible to identify, therefore a main chain as used herein may be a backbone structure or, in the case of a dentrimer, star, or other complex polymers, be a central core structure to which the side chain is extending from, or it may be a heteroatom to which a side chain is attached.

The side chain of the polymer of the present invention extends from the main chain of the polymer. There is at least one, preferably more than one side chain, each side chain comprising a terminal end, the terminal end terminates the side chain. The terminal end of the side chain comprises a functional group that provide dispersion function. The functional group that provides a dispersion function include alkoxy moieties selected from the group of ethoxylated groups, propoxylated groups, butoxylated groups, and combinations thereof. While not providing a dispersion function, one or more of the side chains may also be C₁₋₂₂ aliphatic or C₇₋₂₂ aromatic hydrocarbon. The average number of alkoxy moieties, preferably in block formation, of the side chain of the polymer may be in the range of from about 3 to about 100, and such as from about 5 to about 50, further such as from about 10 to about 40, and even more further such as in the range from about 15 to about 30. At least one side chain of the polymer must contain at least one, more preferably two or more blocks of alkoxy moieties, preferably ethoxylated, propoxylated and butoxylated groups. The terminal end of the side chain may terminate with the alkoxy moieties, but in another embodiment, may be further modified or functionalized dependent upon the type of main chain of the polymer. As used herein “modified” and “functionalized” mean that the terminal end can undergo a chemical reaction to alter the chemical structure, charge density, or other modification to change the chemical and structural properties of the polymer.

In one embodiment the terminal end of the side chain may be further modified or functionalized with a quaternary or protonated nitrogen or other nitrogen derivative, sulfate moieties, sulfonate moieties, carboxylate moieties, phosphorylate moieties, amine oxides or another hydrophobic moiety.

The side chain, other than the terminal end, may also comprise a functional group selected from quaternary nitrogen moieties, protonated nitrogen moieties, other nitrogen derivatives such as acyl moieties, sulfate, carboxylate or a hydrophobic moiety.

In one embodiment the surfactant boosting polymer of the present invention comprises at least one positive charge. As used herein “positive charge” means chemical quatemization of a nitrogen via alkyl, aromatic alkyl and/or alkoxy groups but positive charge also means, use of protonated nitrogens at appropriate conditions for protonization, and mixtures thereof. The surfactant boosting polymer must have a positive charge. The positive charge may be located on the main chain or on at least one side chain.

The surfactant boosting polymer of the present invention is water-soluble. As used herein “water soluble” means that the surfactant boosting polymer is at least 10 ppm soluble in the liquid solution, and such as more than 10 ppm, further such as more than 50 ppm.

The surfactant boosting polymer of the present invention has a weight average molecular weight from about 1500 to about 200,000 daltons, and such as about 2000 to about 100,000 daltons, further such as from about 2200 to about 20,000 daltons, and more further such as from about 2500 to about 8,000 daltons. Molecular weight of a polymer can be determined by a variety of techniques that are discussed in detail in the literature. In this application molecular weight of a polymer was indirectly calculated during synthetic process using ¹H-NMR from structural features of a polymer as discussed below.

Preferred calculation for determining the molecular weight of a polymer is indirectly from known features of a polymer by ^{1H}-NMR as shown and described by formula (I) below.
MW_{polymer}=MW_{backbone}+#side_chain*MW_{side}_{_{—}}_{chain}+MW_{functionalized}_{_{—}}_{groups} formula(I)
where MW_{polymer} of formula (I) is average molecular weight of a polymer; MW_{backbone} of formula (I) is average molecular weight of a backbone, #_{side}_chain of formula (I) is total number of the side chains in a polymer molecule, MW_{side}_chain of formula (I) is an average molecular weight of one side chain and MW_{functionalized groups} of formula (I) is molecular weight of all functionalized groups. Counterions are ignored in the calculation of the molecular weight in this process.

Molecular weight of a backbone can be determined from a known structure of the backbone used for a polymer synthesis and substracting those groups/atoms that would be replaced in an organic synthetic reaction by a side chain and/or by functionalized groups.

Determination of Molecular Weijght via ¹H-NMR—Alkoxy Units

If side chain(s) of a polymer contain alkoxylation, the average molecular weight of the side chain can be determined from the total level of alkoxylation in the polymer via ¹H-NMR. Dissolve samples for ¹H-NMR to 5 wt % level in deuterium oxide (D₂O) and add sodium deuteroxide (NaOD) to adjust to a pH of at least 10 to ensure that any amine groups present in a molecule are not protonated. Protonation of an amine group could interfere with accurate characterization. Obtain the ¹H-NMR spectra on an NMR spectrometer such as the Varian 300 or 500 MHz Fourier transform NMR spectrometers using a 45° pulse and 5 second relaxation delay at ambient temperature (20° C.), using deuteriated trimethyl silyl propionic acid as a reference. In general protons of the polymer main chain have a distinct pattern and shift. Known position and numbers of hydrogen atoms in the main chain are used as standard/reference for quantitation of amount/number of other hydrogens present in a polymer.

For example, the spectrum of ¹H-NMR of hexamethylenediamine (HMDA) shows a narrow peak at chemical shift 2.44-2.64 that corresponds to four methylene hydrogens that are attached to a tertiary nitrogen, (underlined NCH₂CH₂CH₂CH₂CH₂CH₂N) and two broader peaks at shift 1.2- 1.6 ppm corresponding to eight “internal” methylene hydrogens (underlined NCH₂CH₂CH₂CH₂CH₂CH₂N). It is these hydrogens that can be utilized as internal standards for quantification of the amount of other hydrogens in a polymer molecule.

In general hydrogens that belong to the alkoxy moiety, such as poly(ethylene oxide) units elsewhere on the polymer are detected in a broad resonance peak at shift 3.4-3.95. For the remainder of the example, poly(ethylene oxide) units will be discussed, but is not intended to limit the use of other alkoxy units for the present invention rather it will be discussed to simplify the example. Calculation procedure can be modified depending on the nature of a polymer by a person skilled in the art to yield acceptable results. Calculate the peak area of the main chain to and including the peak area of the polyoxyethylene units, to determine the total number of polyoxyethylene units in the polymer molecule as shown in the formula (II) below.
Total # EO=(PA_{EO}/PA_{backbone})(# Protons_{backbone}/4) Formula (II)
where Total # of EO of formula (II) is total number of ethoxy units in polymer molecule, PA_{EO} of formula (II) is total peak area of hydrogens in all ethoxy units in a polymer, # Protons_{backbone} of formula (II) is number of hydrogens in the main chain that were chosen as internal standard. This calculation can be alternated and modified in a consistent manner to determine total amount of other alkoxylated/alkylated units in a polymer molecule.

Calculate the number of alkoxylated units per side chain via dividing the total number of alkoxylated units in a polymer and the number of side chains as shown in the formula (III) below:
#AO_{side chain}=total #AO/# side chains formula (III)
where #AO_{side chain of} formula (III) is the number of alkoxylated units per side chain; total #AO of formula (III) is total number of alkoxylated units in a polymer; and # side chains of formula (III) is number of side chains in a polymer.

Another example is the calculation of the ethoxylation level of a polymer such as polyethyleneimine analogues. ¹H-NMR shows a broad peak at chemical shift 2.2-2.8 ppm for the protons of all the methylene groups attached to nitrogen and a broad peak at chemical shift 3.2-3.8 ppm for the protons of the methlyene groups of the poly(ethylene oxide) chains (CH₂CH₂O ). Total # of EO repeat units can be calculated using formula IV as shown below.
Total # EO=(PA_{EO}/PA_{nitrogen methylenes})(# Protons_{nitrogen methylenes}/4) Formula (IV)
Where Total # of EO in formula IV is total number of ethoxylated units in a polymer molecule, PA_{EO} in formula IV is total peak area of hydrogens in all oxyethylene groups in a polymer molecule, PA_{nitrogen methylenes} in formula IV is total peak area of hydrogens of all methylene groups attached to nitrogen (both in the backbone of the starting amine material and from the ethoxylated units attached directly to the nitrogens), # protons_{nitrogen methylenes} in formula IV is number of hydrogens in the backbone of methylene groups of ethoxylated units attached directly to nitrogen that were chosen as internal reference. Number of ethoxylated units per side chain can be calculated from formula III as shown above.
Determination of Molecular Weight Via ¹H-NMR—Level of Quaternization

The level of quaternization in a polymer can be also determined from ¹H-NMR. ¹H-NMR shows a broad resonance peak for the protons of the methylene groups that are attached to tertiary nitrogens. Upon the quaternization of a nitrogen, the signal of these methylene groups diminishes proportionately to that of level of quaternization. From this correlation one can calculate the average level of quatemization. For example, for hexamethylenediamine (HMDA) the level of quaternization can be calculated by a following relationships of formulae (V) and (VI):
PA_{backbone internal methylenes}−2*(PA_{tertiary methylenes})=PA_{quatemary internal methylenes} formula (V)
and
PA_{quatemary internal methylenes}/PA_{backboneintemal methylenes}*100=% Quaternization Level. formula (VI)
where PA_{tertiary methylenes} of formula (V) is the peak area of protons at chemical shift 2.44-2.64 that corresponds to four methylene hydrogens are attached to tertiary nitrogen, (underlined NCH₂CH₂CH₂CH₂CH₂CH₂N); PA backbone internal methylenes of formula (V) is the peak area of protons at shift 1.2- 2.1 ppm corresponding to eight “internal” methylene hydrogens (underlined NCH₂CH₂CH₂CH₂CH₂CH₂N) and PA_{quatemary internal methylenes} of formulae (V) and (VI) is the peak area of methylene protons attached to quartenary nitrogens present in the HMDA. Similar approach can be deployed also for other backbones and/or side chains.
Determination of Molecular Weight Via ¹H-NMR—Level of Sulfation or Anionic Unit

Calculate the level of sulfation via ¹H-NMR through the determination of shifts of protons of methylene groups attached to sulfate groups verses the protons of methylene group unmodified by sulfate groups. Alternatively, “standard protons” of a polymer main chain can be used to estimate protons of methylene groups attached to sulfate groups. Example of such calculation is shown in formulae (VII) and (VIII) below:
PA_{theoretical 100% sulfate}=(PA_{backbone internal methylenes})(# Protons_{tenminal methylene groups of EO chains}/# Protons_{backbone internal methylenes}). Formula (VII)
(PA_{sulfate methylenes}/PA_{theoretical 100% sulfate})*100=% Sulfation Level. Formula (VIII)
Where PA_{theoretical 100% sulfate} in formula (VII) and (VIII) is the theoretical area of the peak at shift 4.15-4.25 ppm corresponding to protons of methylene groups at end of ethoxylate chains attached to sulfate groups if all such sites were 100% sulfated, PA_{backbone internal methylenes} in formula (VII) is peak area of protons at shift 1.2-2.1 ppm corresponding to eight “internal” methylene hydrogens (underlined NCH₂CH₂CH₂CH₂CH₂CH₂N), # Protons_{terminal methylene groups of EO chains} in formula (VII) is number of hydrogens of all the terminal methylene groups of the ethoxylate chains, # Protons_{backbone internal methylenes} in formula (VII) is number of hydrogens in the backbone that were chosen as internal reference, PA_{sulfate methylenes} in formula (VIII) is the actual measured area of the peak at shift 4.15-4.25 ppm corresponding to protons of methylene groups at end of ethoxylate chains attached to sulfate groups. Similar approach can be deployed also for other backbones and/or side chains than HMDA. Efficiency of surfactant boosting polymer is measured by SB₅₀. “SB₅₀” as used herein is the experimental molar measure of concentration of polymer that yields a 50% increase of available surfactant in a liquid solution over that of a blank (blank being equivalent surfactant solution without a polymer). The liquid solution comprising a specified amount of at least one surfactant, at least one surfactant boosting polymer, and a specified hardness of a liquid, preferably aqueous, solution. SB₅₀ is experimentally determined as a measure of efficiency of surfactant boosting polymer as a percent soluble C₁₀₋₁₃ linear alkyl benzene sulfonate surfactant (hereinafter “LAS”). It has been found that SB₅₀ provides a measure of efficacy and comparison among individual polymers and also correlates to the polymer efficacy to prevent growth of liquid crystalline surfactant phases on surfaces, thus improving general cleaning. One skilled in the art can utilize this method in determine the weight of anionic units other than sulfate/sulfonate, such as carbonate.
Measurement and Calculation of SB₅₀

Transfer 18.0 ml of a 17.8 gpg (grains-per-gallon) hardness solution (2 mol of Ca²⁺ as CaCl₂:1 mol of Mg²⁺ as MgCl₂) to a scintillation vial. The evaluation of the surfactant boosting polymer may be done at various pHs as environments may vary for desired usages. For example, hard surface cleaners for bathrooms have low pHs, while liquid laundry detergents have comparatively higher pHs. At various pHs, suitable buffer solutions can be used. Below, see non-limiting examples of such buffers. Alternatively if solutions of the investigated species are in the desired pH range, no buffer addition is necessary. To determine percent soluble linear alkyl benzene sulfonate (LAS) at 6.75, 13.50, 20.25, and 27.00 ppm polymer level, add 0.25, 0.50, 0.75, and 1.00 ml, of 540 ppm polymer solution, respectively to scintillation vials. Add 0.75, 0.50, 0.25, and 0 ml, respectively, of deionized water (16 MΩ or higher) to the scintillation vial to bring the volume to 19.05 mL. Cap the vial and stir well for about 1 minute. Add 1.0 ml of 10,000 ppm LAS solution to the test vial. Cap the test vial and briefly mix by vigorously shaking for about 30 seconds and allow to sit for 15 minutes. After 15 minutes, transfer approximately 8 ml of the solution to a 10 ml syringe. Filter the solution through a 0.10 Jim membrane syringe filter. These syringe filters may be purchased from variety of sources and suppliers, such as VWR, Pall, Gelman, and can be found under a trade name SUPOR®. Discard the first 3 mL of filtrate and collect the remaining filtrate. Dilute 0.5 mL with 0.5 mL of ethanol and analyze by gradient elution reversed phase HPLC to determine the amount of LAS. Amount of LAS in solution can be calculated from the sum of all peak areas of all LAS components of the sample and the sum of all peak areas of all LAS components of an external standard as shown in formula (IX). Alternatively, several standards of the same concentration may be analyzed, in which case sum of all peak areas of all LAS components is averaged.

$$\frac{P {A}_{sample}}{P {A}_{standard}} * {ppm}_{standard} = ppm L A {S}_{soluble} \qquad formula ( IX )$$

Where PAₛₐₘₚₗₑ of formula (IX) is the total peak area of all components of LAS in the sample, PA_{standard} of formula (IX) is the average of peak area of all components of LAS in the standard; and ppmLAS_{soluble} of formula (IX) is ppm of soluble LAS surfactant in the solution. The percent (%) of soluble LAS can be determined by dividing ppm LAS_{soluble} of formula (IX) by total ppm of LAS present in the solution before filtration and multiplying by 100 as shown in formula (X) below.

$$\frac{ppm L A {S}_{soluble}}{ppm L A {S}_{total}} * 100 = \% L A {S}_{soluble} \qquad formula ( X )$$

where ppmLAS_{soluble} of formula (X) is ppm of soluble LAS in the solution, ppmLASₜₒₜₐₗ of formula (X) is total ppm of LAS present in the solution before filtration, and % LAS_{soluble} of formula (X) is mass percent of LAS soluble in the solution. Alternatively, the amount of LAS in the sample can be also determined by MS, NMR and/or by another technique specific to analysis of surfactants and/or LAS.

Plotting of the percentage of soluble LAS, % LAS_{soluble,} verses ppm of a polymer leads to a “mass efficient curve”. Mass concentration of a polymer (ppm) is then converted to a molar measure, SB, of a polymer concentration by formula (XI):

$$S B = \frac{{ppm}_{polymer} * 0.037}{{MW}_{polymer}} * {10}^{6} \qquad formula ( XI )$$

wherein SB of formula (XI) is a measure of a molar concentration of a polymer; ppm_{polymer} of formula (XI) is ppm amount of polymer in a testing vial; and MW_{polymer} of formula (XI) is molecular weight of a polymer as described in the method above. Plotting of the percentage of soluble LAS, %LAS_{soluble}, verses SB gives a molar efficiency curve, which through interpolated and/or extrapolated from experimental data derived from polymers of a representative set, discussed below, gives the SB₅₀ value. SB₅₀ is SB concentration of a polymer that yields in 50 percent increase of LAS_{soluble} over that of the blank (no polymer). Generally the blank (no polymer) has a % LAS_{soluble} of about 18%. This means that the SB₅₀% correlates to % LAS_{soluble} of 68%.

The smaller the SB₅₀ value, the more efficient a surfactant booster polymer is in preventing the formation of higher ordered surfactant aggregates (such as vesicles and crystals). As used herein, “surfactant boosting” is demonstrated by a polymer if its SB₅₀ value is smaller than that of about 430. Preferably, SB₅₀ is from 1 to 430, more preferably from 1 to 350, even more preferably from 1 to 275, even more preferably from 1 to 200, and even more preferably from 1 to 150.

The present invention relates to a method of preventing large ordered aggregates of at least one surfactant comprising the use of a minimum molar amount of a polymer having a solubility of at least 10 ppm at 20° C., having a weight average molecular weight from about 1500 to 200,000 daltons; and comprising a main chain and one or more side chains extending from the main chain; the side chain comprising a terminal end such that the terminal end terminates the side chain; at least one side chain comprising an alkoxy moiety, wherein the polymer has an SB₅₀ value of 430 or less when in the presence of a surfactant, such as an anionic surfactant, further such as LAS, and water having at least 2 gpg free ions. Preferably the minimum molar amount will be between 6 and 30 ppm polymer, more preferably 6.75, 13.50, 20.25, and 27.00 ppm polymer.

The present invention also relates to a method of increasing the level of available surfactant of at least one surfactant, such as an anionic surfactant, further such as LAS, comprising the use of a minimum molar amount of a polymer comprising solubility of at least 10 ppm at 20° C., a weight average molecular weight from about 1500 to 200,000 daltons; and comprising a main chain and one or more side chains extending from the main chain and the side chain comprising a terminal end such that the terminal end terminates the side chain; at least one side chain comprising an alkoxy moiety, wherein the polymer has an SB₅₀ value of 430 or less when in the presence of the surfactant and water having at least 2 gpg free ions. Preferably the minimum molar amount will be between 6 and 30 ppm polymer, more preferably 6.75, 13.50, 20.25, and 27.00 ppm polymer.

The present invention also relates to a method of identifying, selection, and designing a surfactant boosting polymer by using a correlation developed by quantitative structure-activity relationship (QSAR) to identify, select, design, or any combination thereof, the preferred polymers that provide desired surfactant boosting properties of the present invention. The method of the present invention comprises the steps of

(a) calculating a correlation with correlation coefficient R=0.853, represented below as Correlation (I):
log(1/SB₅₀)=−2.150−0.903*CD₂+0.227*COPC−0.792*CD₆+0.123*ESO₄−0.007*SH_{Bint10}+0.112*dxvp5 Correlation (I)
wherein CD₂ in Correlation (I) is positive charge density of a polymer; COPC in Correlation (I) is count of positive charges in a polymer molecule; CD₆ in Correlation (I) is average charge density around a side chain; ESO₄ in Correlation (I) is total number of negative charges on side chains; SH_{Bint10} in Correlation (I) is the sum of the product topological state indices for intramolecular hydrogen-bonding pairs separated by 10 edges (bonds) as described by Kier and Hall; and dxvp5 in Correlation (I) descriptor is the difference valence corrected 5^{th} order path molecular connectivity index, as described by Kier and Hall [L. H. Hall and L. B. Kier, “The Molecular Connectivity Chi Indexes and Kappa Shape Indexes in Structure-Property Relations”, in Reviews of Computational Chemistry, Volume 2, Chap 9, pp 367-422, Donald Boyd and Kenny B. Lipkowitz, eds., VCH Publishers, Inc. (1991)]. A further discussion of these parameters is included below, however immediately below is a brief summary of QSAR modeling theory and the determination of Correlation (I).

The process further comprises the step of selecting an appropriate polymer based upon the calculation of Correlation (I) such that the polymer comprises solubility of at least 10 ppm at 20° C., a weight average molecular weight from about 1500 to 200,000 daltons; and comprises a main chain and at least one side chain extending from the main chain and the side chain comprising a terminal end such that the terminal end terminates the side chain; at least one side chain comprising an alkoxy moiety, optionally, the polymer further having at least one positive charge; wherein the polymer exhibits a SB₅₀ value of 430 or smaller in the presence of the surfactant. Selection is based upon matching the calculation of Correlation (I) with suitable functional groups for the main chain and side chain chemical structures. As one of skilled in the art determines the suitable portions of the main chain and side chain desired, a newly designed surfactant boosting polymer results.

OSAR Modeling Theory

Quantitative structure-activity relationship (QSAR) or quantitative structure-property relationship (QSPR), and is a method wherein the structures of a representative set of materials are characterized by physical features that are used to predict a property (characteristic) of interest. For example, logP (base-10 logarithm of the octanol-water partition coefficient P), fragment constants like Hammett's sigma, or any of a large number of computed molecular descriptors (for example, see P. C. Jurs, S. L. Dixon, and L. M. Egolf, Representations of Molecules, in Chemometric Methods in Molecular Design, Han van de Waterbeemd, ed., published by VCH, Weinheim, Germany, 1995, of a representative set may be utilized in a QSAR method to identify materials, select materials, and even design materials having the desired property (characteristic), such as surfactant boosting properties.

As used herein, a “representative set” (otherwise known as a “training set”) of materials is a collection of materials chosen to represent the property (characteristic) of interest and physical features, such as molecular structure types (i.e., molecular descriptors) of those materials, which will represent a spectrum (e.g., from desired to not desired) of the property (characteristic) of interest. The size of the representative set is dependent on the diversity of the physical features and the range of parameters for which the model needs to be validated.

Size of the Representative Set

Typically, one needs to have about 20 to about 25 materials to begin to generate statistically valid models. However, it is possible to obtain valid models with smaller sets of materials if there is a large degree of similarity between the physical features. A general rule of thumb suggests that the final QSAR model should include at least about five different materials in a representative set for each parameter (physical feature) in the QSAR model in order to achieve a statistically stable equation and to avoid “overfitting” the data, that is the inclusion of statistical noise in the model.

The property range of spectrum being modeled must also be broad enough to detect statistically significant differences between materials of the representative set in view of the magnitude of the uncertainty associated with experimental measurement. For example, a typical minimum range of biological properties is about two orders of magnitude (100 fold difference between the lowest and highest values) because of the relatively large uncertainty associated with biological experiments. In the case of polymers, the property range for physical properties (e.g. boiling points, surface tension, aqueous solubility) is usually smaller because of the greater accuracy and precision achieved in measuring such properties.

Description Of Physical Features Of The Representative Set

Small Molecules

One approach for describing the physical features of the representative set comprising small molecules is the group contribution method. In this approach, the structure of the molecule in the representative set is divided into small fragments. Software keeps track of the number and type of each fragment. A database is then searched and a fragment-constant is found for each fragment in the structure of the molecule. The physical feature is then estimated by calculating the sum of constants for all fragments found in the structure of the molecule, multiplied by the number of times that fragment is found in the structure of the molecule. See A. Leo, Comprehensive Medicinal Chemistry, Vol. 4, C. Hansch, P. G. Sammens, J. B. Taylor and C. A. Ramsden, Eds., p. 295, Pergamon Press, 1990.

Alternatively, whole-molecule structure descriptors may be used to define the physical features in developing a QSAR model. See “Development of a Quantitative Structure - Property Relationship Model for Estimating Normal Boiling Points of Small Multifunctional Organic Molecules”, David T. Stanton, Journal of Chemical Information and Computer Sciences, Vol. 40, No. 1, 2000, pp. 81-90. In the whole-molecule approach, the physical features are not divided into fragments of the structural features, but rather measurements of a variety of structural features are computed using the whole structure.

Polymers

Approaches that are useful for small molecules however, are typically not applicable for developing predictive QSAR models for polymers, requiring very large sets of experimental data. The term “polymer” as used herein comprises both homopolymer and copolymer, and mixtures thereof. Except for some natural polymers such as enzymes, most polymers, especially synthetic polymers are mixtures of polymeric molecules of various molecular weights, sizes, structures and compositions. Polymers are characterized most commonly by their average properties, such as, average molecular weight, viscosity, glass transition temperature, melting point, solubility, cloud point, heat capacity, interfacial tension and adhesion, refractive index, stress relaxation, sheer, conductivity, permeability, and the like. Another common way that polymers are characterized is by the number and type of monomers.

Applications of QSAR/QSPR approaches to polymers typically use physical feature descriptors derived for repeated units, such as molecular weight of a repeat unit, end-to-end distance of a repeat unit in its fully extended conformation, Van der Walls volume of a repeat unit, positive and negative partial surface area normalized by the number of atoms, topological Randic index computed for a repeating unit, cohesive energy which can be estimated using group contribution method, and a parameter related to the number of rotational degrees of freedom of the backbone of a polymer chain, that can be derived from the structure of a repeat unit. See Journal of Applied Polymer Science, Vol. 49, 1993, pp. 1331-1351. Alternatively, topological connectivity indices may be used as described by J. Bicerano in Prediction of Polymer Properties, 2^{nd} edition, Marcel Dekker, Inc., New York, Basel, 1996.

Homopolymers

Most QSAR/QSPR polymer models correlate theoretically calculated physical feature descriptors of a repeating unit for homopolymers with bulk physical properties of the polymer, such as glass transition temperature, refractive index, and the like. In addition, development of these QSAR models requires atomic and/or group correction terms. Another approach to predicting properties of homopolymers of a regular structure is to model three repeating units for each polymer and calculate descriptors only for the middle unit. In this way influence of the adjacent units can be also taken into account, as described by Katritzky A. R. et al. in Journal of Chemical Information and Computer Sciences vol. 38, 1998, pp 300-304.

Copolymers One approach to predicting properties of copolymers is to treat blocks of a copolymer as separate polymers and assume simple additivity rules for prediction of extensive properties as described by J. Bicerano in Prediction of Polymer Properties, 2^{nd} edition, Marcel Dekker, Inc., New York, Basel, 1996. Calculation of the properties of random copolymers require using weighted averages (from molar fractions of repeating units) of all extensive properties and appropriate definitions for the intensive properties in terms of the extensive properties as described by J. Bicerano in Prediction of Polymer Properties, 2^{nd} edition, cited herein above.

Product of OSAR Modeling

The QSAR model developed is a multivariate. That means that the model will involve many parameters and is a linear regression equation computed by regressing a selected set of physical features, such as molecular descriptors, against measured values of the property (characteristic) of interest (e.g., Y=m₀+m₁x₁ . . . +Mₙx_{npk , wherein Y is the measured property (characteristic) of interest, x}₁, x₂. . . xₙ are the physical features, m₀, m₁ . . . mₙ are the regression coefficients, and n is the number of physical features in the model).

Determining Quality Of QSAR Model

Coefficient of Multiple Determination

The coefficient of multiple determination (R²) is used to judge the quality of a regression model. R² measures the proportion of the variation of the property (characteristic) being modeled (dependent variable) that is accounted for by the set of physical features (independent variables) in the model. The coefficient of multiple correlation, commonly called the correlation coefficient, or R which is the positive square root of R², relates to the correlation between the calculated values (using the model) and the experimental values. All commercial statistical packages report R² as a standard part of the results of a regression analysis. While a high R² value is necessary for an acceptable QSAR model it, in and of itself, is not a sufficient condition for an acceptable QSAR model. Overfitting the data may result if validation does not occur.

Validation of QSAR Model Once a QSAR model has been developed, it must be validated. This process includes (1) the consideration of statistical validation of the model as a whole (e.g., overall-F value from analysis of variance, AOV); (2) the consideration of statistical validation of the individual coefficients of the equation (e.g., partial-F values), (3) analysis of collinearity between the independent variables (e.g. variance inflation factors, or VIF), and (4) the statistical analysis of stability (e.g., cross-validation). Most commercial statistics software can compute and report these diagnostic values. It is preferred to employ an external prediction set. As used herein an “external prediction set” is a set of materials for which the property (characteristic) of interest has been measured experimentally, but was not included in the development of the QSAR model. The external prediction set is then used to evaluate and demonstrate the predictive accuracy of the QSAR model.

The present invention also relates to a QSAR method for identify, selection, and designing polymers wherein combination of the physical features of the polymer used that are structural descriptors, which are experimentally generated and/or derived using one or more analytical methods and structural descriptors that are calculated from the molecular structure of a polymer.

Correlation (I) and Boundary Conditions

As mentioned above, the present invention further relates to a method of selecting, a method of identifying, and a method of designing suitable surfactant boosting polymer comprising the step of calculating Correlation (I).
log(1/SB₅₀)=−2.150−0.903*CD₂+0.227*COPC−0.792*CD₆+0.123*ESO₄−0.007*SH_{Bint10}+0.112*dxvp5 Correlation (I)
wherein CD₂ of Correlation (I) is a positive charge density of a polymer; COPC of Correlation (I) is count of positive charges in a polymer; CD₆ of Correlation (I) is average charge density around a side chain; ESO₄ of Correlation (I) is total number of negative charges on side chains; SH_{Bint10} in Correlation (I) is the sum of the product topological state indices for intramolecular hydrogen-bonding pairs separated by 10 edges (bonds); and dxvp5 in Correlation (I) descriptor is the difference valence corrected 5^{th} order path molecular connectivity index. SB₅₀, as discussed above, is a measure of a molar concentration of polymer that yields a 50 percent increase of % LAS_{soluble} over that of a blank (no polymer). Without being bound by a theory, it is believed that SB₅₀ correlates to a polymer efficacy to prevent the growth of liquid crystalline surfactant phases on surfaces, and thus improving general cleaning.

The method further comprises the step of selecting an appropriate polymer based upon the calculation of Correlation (I) such that the polymer comprises solubility of at least 10 ppm at 20° C., a weight average molecular weight from about 1500 to 200,000 daltons; and comprises a main chain and at least one side chain extending from the main chain and the side chain comprising a terminal end such that the terminal end terminates the side chain; at least one side chain comprising an alkoxy moiety, the polymer further having at least one positive charge; wherein the polymer exhibits a SB₅₀ value of 430 or smaller in the presence of the surfactant.

CD₂ of Correlation (I)

CD₂ is positive charge density of a polymer and is calculated by formula

$$C {D}_{2} = \frac{\# {of N}^{+}}{M {W}_{polymer}} * 1000 \qquad formula ( XII )$$

where #ofN⁺ of formula (XII) is the number of positively charged nitrogens (or other positively charged heteroatoms) in a polymer, included even if the polymer does not contain a positive charge, should that be the case, #ofN⁺ will be equal to zero; and MW_{polymer} of formula (XII) is molecular weight of a polymer determined by the methods specified above. Alternative methods for determining, or which leads to the determination of number average molecular weight may be used.

For polymers with quaternization, #ofN⁺ of formula (XII) can be calculated by multiplication of total number of nitrogens (or heteroatoms) and level of quaternization in the polymer as described above. For a polymer that does not have a quarternary charge, but are designed to be used in pH where protonation of nitrogen (or heteroatom) occurs, #ofN⁺ of formula (XII) is determined by multiplication of total number of nitrogen (or heteroatom) and level of protonation of the polymer at given pH. If the polymer does not contain a positive charge, should that be the case, #ofN⁺ will be equal to zero.

Prefered materials have CD₂ of formula (XII) lower than 2, preferably materials have CD₂ of formula (XII) from 0 to 2, more preferably from 0 to 1.2, even more preferably from 0 to 0.7 and most preferably from 0.1 to 0.4.

COPC of Correlation (I)

COPC is the count of positive charges in a polymer; generally the positive charge is the number of all positively quaternized and/or protonized nitrogens in a polymer. Preferred materials have COPC values between 0 and 20, preferably from 0 to about 10; more preferably from 0 to about 3; preferably from 1 to 20, more preferably from 1.8 to 20, and most preferably from 3 to 20.

CD of Correlation (I)

CD₆ is average charge density around a side chain is calculated from formula (XIII):

$$C {D}_{6} = \frac{\# valence ( \# anionic\_ {side}_{-} \_chains )}{{\#}_{side\_chains} * M {W}_{side\_chain} } * 1000 \qquad formula ( XIII )$$

where #_{side}_{_{—}}_{chains} of formula (XIII) is number of side chains in a polymer molecule; #valence is the valence charge of an anionic group in the side chain, for example sulfate has a valance of −1, phosphate has a valence of −2; #_{anionic}_{_{—}}_{side}_{_{—}}_{chains of formula (XIII) is the number of sulfated and/or anionically modified side chains; #}_{anionic}_{_{—}}_{side}_{_{—}}_{chains} of formula (XIII) is calculated by multiplication of percent anionic and the number of side chains in a polymer molecule. MW_{side}_{_{—}}_{chain} of formula (XIII) is average molecular weight of a side chain determined by formula (XIV):

$$M {W}_{side\_chain} = \frac{\sum ( {\#}_{AO} * M {W}_{AO} ) + \sum ( {\#}_{modifying\_groups} * M {W}_{modyifying\_groups}}{{\#}_{side\_chains}} * 1000 \qquad formula ( XIV )$$

where MW_{side}_{_{—}}_{chain} of formulae (XIII) and (XIV) is the average molecular weight of a side chain as determined by the method described above; Σ(#AO*MW_{AO}) of formula (XIV) is sum of the product of total number of alkoxylated units and the molecular weight of a alkoxylated unit, the molecular weight of the alkoxylated unit determined as described above; and Σ(#_{modifiyng groups}*MW_{modifying groups}) of formula (XIV) is sum of the product of total number of modifying units (functionalization units) and molecular weight of a modifying unit, determined as described above.

Preferred materials have CD₆ of Formula (XIII) value between 0 and 1.5, preferably between 0 and 1, more preferably from 0 to 0.7, and even more preferably from 0 to 0.4.

ESO of Correlation (I)

ESO₄ is the total number of negative charges on side chains of the polymer and is calculated by formula (XV):
ESO₄=#valence(% anionic level)*# side chains formula (XV)
ESO₄ is a parameter that interacts and changes dependent on the other parameters of Correlation (I). #valance is the charge valence of the anionic group, such as that described in formula (XIII) above. % anionic level is the same as that described in formula (XIII) above, and # of side chains is the same as that described in formula (XIII) above. Thus the ESO₄ value may vary anywhere between 0 and 15, preferably the ESO₄ values are determined by other parameters of Correlation (I), primarily by CD₂ and CD₆ of Correlation (I).
SH_{Bint10} of Correlation (I)

SH_{Bint10} is the sum of the product topological state indices for intramolecular hydrogen-bonding pairs separated by 10 edges (bonds) as described by Kier and Hall, listed below. This parameter was computed based only on the polymer main chain, and represents the potential for internal, or intramolecular, hydrogen bonding and is determined as follows: There is a donor and an acceptor separated by 10 bonds along a path, the donor is characterized by the Hydrogen E-State value, the acceptor is characterized by the E-State value, and the internal hydrogen bond descriptor, SHBintlO, is computed as the product of the Hydrogen E-State value times the E-State value (see Kier, L. B.; Hall, L. H. Molecular Structure Description—The Electrotopological State, Academic: San Diego, Calif., 1999). SHBint,o values may be anywhere between 0 and 30. Preferred values of this parameter are highly dependent on values of other descriptors, primarily of that COPC and dxvp5.

dxvp5 of Correlation (I)

The dxvp5 descriptor is the difference valence corrected 5^{th} order path molecular connectivity index, as described by Kier and Hall [L. H. Hall and L. B. Kier, “The Molecular Connectivity Chi Indexes and Kappa Shape Indexes in Structure-Property Relations”, in Reviews of Computational Chemistry, Volume 2, Chap 9, pp 367-422, Donald Boyd and Kenny B. Lipkowitz, eds., VCH Publishers, Inc. (1991)]. This molecular descriptor was computed based only on the polymer main chain, and represents a structural feature that involves 5 contiguous acyclic bonds that excludes branching via side chains (e.g., a path). The valence-correction allows this parameter to discriminate between carbon atoms and other heteroatoms (e.g., nitrogen, oxygen) included in the five-bond fragment. The “difference” designation indicates that the sigma-bond contribution has been subtracted in order to reflect only the pi and valence electron contributions. This parameter primarily interacts with COPC and SH_{Bint10} thus its preferred value is highly dependent on other structural features of a polymer. The values of this descriptor can be anywhere between −7 and 0.

Nonlimiting examples of classes of surfactant boosting polymers include, polysiloxanes and derivatives thereof; polyethyleneoxy/polypropyleneoxy block copolymers, derivatives thereof, homologues thereof, polysaccharide polymers, homologues thereof, derivatives thereof (e.g., alkyl, acyl, carboxy-, carboxymethyl-, nitro-, sulpho-, and mixtures thereof); polyvinyl homopolymers and/or copolymers, and derivatives thereof, polyvinyl alcohol, block and/or random copolymers of polyvinyl pyridine N-oxide, polyvinyl pyrrolidone, polyvinyl imidazole, block and/or random copolymer of polyvinyl pyrrolidone and polyvinyl imidazole, including structural homologs and derivatives thereof, e.g., charged, hydrophilic, and/or hydrophobic modifying groups, e.g., ethoxylated, propoxylated, alkylated, and/or sulfonated groups, polystyrene, block and/or random copolymer of polystyrene with polymaleate, polyacrylate, or polymethacrylate, polyvinyl carboxylic acids, alkyl esters thereof, amides thereof, and mixtures thereof; polyamines and chemically modified derivatives thereof, polyamide, homologues thereof and/or derivatives thereof, and polyamideamines; polyterephthalates, isomers thereof, homologues thereof, and/or derivatives thereof, e.g., sulfated. sulfonated,. ethoxylated, alkylated (e.g., methyl, ethyl, and/or glycerol) derivatives, polyesters and chemically modified derivatives thereof; polyurethane; condensation products of imidazole and epichlorhydrin, including charged, hydrophilic, and hydrophobic modifying groups, e.g., ethoxylated, propoxylated, alkylated, and/or sulfonated groups; aromatic polymeric condensates of formaldehyde, including ether-bridged and methylene-bridged phenols, naphthalenes, substituted naphthalenes; and mixtures thereof. The copolymers given herein above can be further modified to provide desired properties by incorporation of one or more of aryl, alkyl, allyl, methyl, ethyl, ethoxylate, propoxylate, nitro, amino, imido, sulpho, carbo, phospho, groups, and the like. The polymers can have any architecture, including block, random, graft, dendritic, and the like.

Table I below lists molecular descriptors and structures of non-limiting preferred synthetized new materials with values of measured SB₅₀ and predicted SB₅₀.

TABLE I
below lists molecular descriptors and structures of non-limiting preferred
synthetized new materials with values of measured SB₅₀ and predicted SB₅₀.

| | | | | | | | SB₅₀ | SB₅₀ |
|---|---|---|---|---|---|---|---|---|
| Name | COPC | ESO4 | CD₂ | CD₆ | dxvp5 | SH_{Bint10} | measured | predicted |
| | 0.72 | 1.5 | 0.155 | 0.323 | −0.8717 | 0 | 239.5 | 198.0 |

| | |
|---|---|
| Structure 1 | 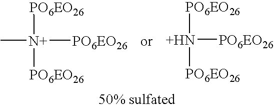 |

| | | | | | | | |
|---|---|---|---|---|---|---|---|
| 0.72 | 2.7 | 0.151 | 0.570 | −0.8717 | 0 | 261.5 | 219.5 |

| | |
|---|---|
| Structure 2 | 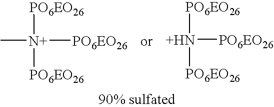 |

| | | | | | | | |
|---|---|---|---|---|---|---|---|
| 1 | 0 | 0.32 | 0 | −0.7384 | 0 | ND | 198 |

| | |
|---|---|
| Structure 3 | 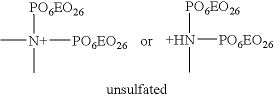 |

| | | | | | | | |
|---|---|---|---|---|---|---|---|
| 1 | 1 | 0.32 | 0.32 | −0.7384 | 1 | ND | 269 |

| | |
|---|---|
| Structure 4 | 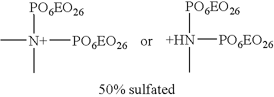 |

| | | | | | | | |
|---|---|---|---|---|---|---|---|
| 1 | 1 | 0.212 | 0.215 | 0 | 0 | 112 | 145 |

| | |
|---|---|
| Structure 6 | 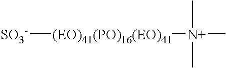 |

| | | | | | | | |
|---|---|---|---|---|---|---|---|
| 2 | 1.88 | 0.264 | 0.253 | −0.996 | 1.752 | 61.5 | 107.1 |

| | |
|---|---|
| Structure 7 | 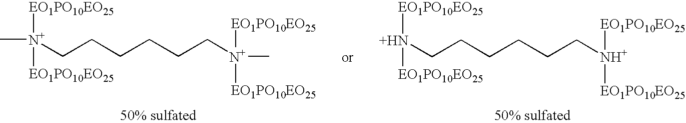 |

| | | | | | | | |
|---|---|---|---|---|---|---|---|
| 2 | 3.52 | 0.260 | 0.466 | −0.996 | 1.752 | 68.1 | 98.4 |

| | |
|---|---|
| Structure 8 | 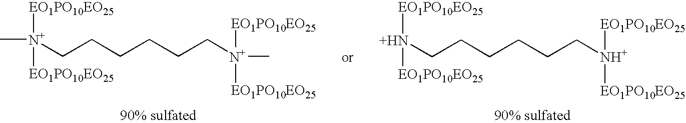 |

| | | | | | | | |
|---|---|---|---|---|---|---|---|
| 1.8 | 1 | 0.274 | 0.155 | −0.996 | 1.752 | 104.9 | 130.2 |

| | |
|---|---|
| Structure 9 | 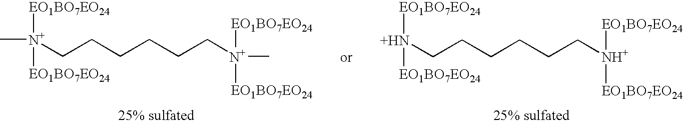 |

| | | | | | | | |
|---|---|---|---|---|---|---|---|
| 1.8 | 2.16 | 0.270 | 0.331 | −0.996 | 1.752 | 4.7 | 128.2 |

| | |
|---|---|
| Structure 10 | 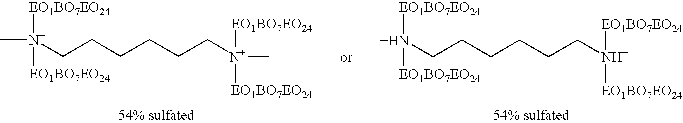 |

| | | | | | | | |
|---|---|---|---|---|---|---|---|
| 3.96 | 0 | 0.472 | 0.000 | −1.683 | 0 | 66.9 | 73.8 |

| | |
|---|---|
| Structure 11 | 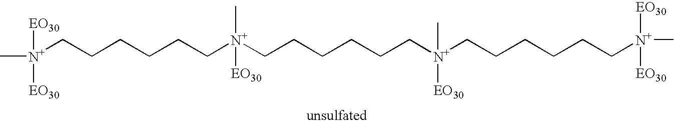 |
| | 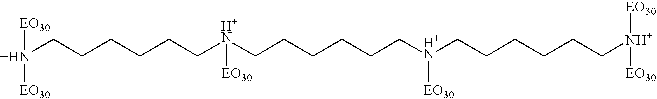 |

| | | | | | | | |
|---|---|---|---|---|---|---|---|
| 3.8 | 2.22 | 0.444 | 0.271 | −1.683 | 0 | 86.5 | 66.2 |

| | |
|---|---|
| Structure 12 | 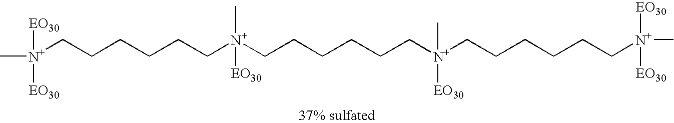 |
| | 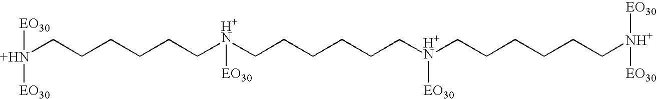 |

| | | | | | | | |
|---|---|---|---|---|---|---|---|
| 2 | 0 | 0.451 | 0.000 | −0.996 | 0 | 154.8 | 164.6 |

| | |
|---|---|
| Structure 13 | 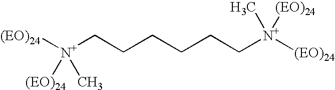 |

| | | | | | | | |
|---|---|---|---|---|---|---|---|
| 2 | 2 | 0.436 | 0.449 | −0.996 | 0 | 301.1 | 205.4 |

| | |
|---|---|
| Structure 14 | 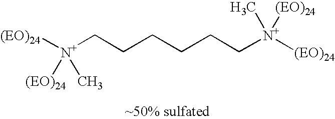 |

| | | | | | | | |
|---|---|---|---|---|---|---|---|
| 3 | 1.25 | 0.592 | 0.273 | −1.014 | 1.761 | 119.1 | 156.3 |

| | |
|---|---|
| Structure 15 | 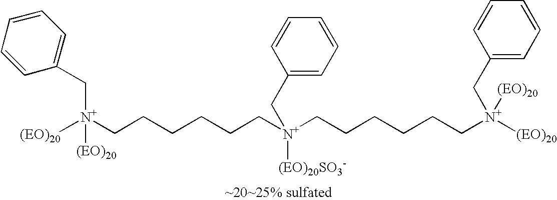 |

| | | | | | | | |
|---|---|---|---|---|---|---|---|
| 4 | 0 | 0.514 | 0.000 | −1.819 | 23.33 | 132.3 | 120.7 |

| | |
|---|---|
| Structure 16 | 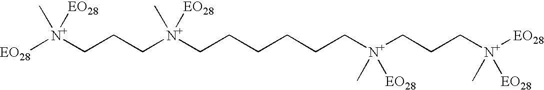 |

| | | | | | | | |
|---|---|---|---|---|---|---|---|
| 7 | 0 | 0.614 | 0.000 | −5.546 | 0 | 60.0 | 55.1 |

| | |
|---|---|
| Structure 17 | 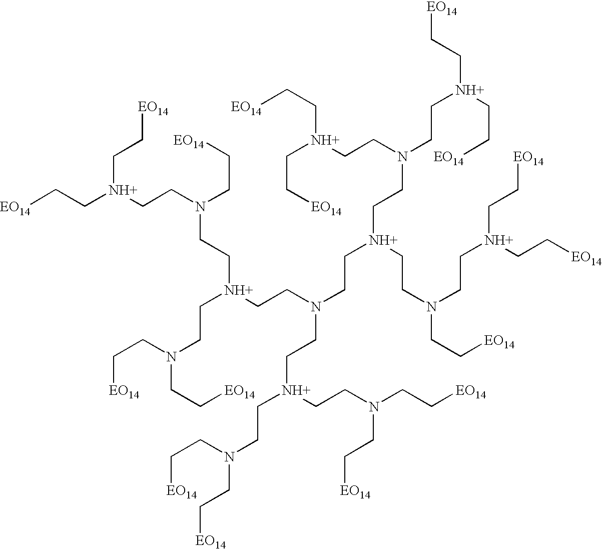 |

| | | | | | | | |
|---|---|---|---|---|---|---|---|
| 21.5 | 0 | 1.311 | 0.000 | ND | 0 | 54.7 | ND |

| | |
|---|---|
| Structure 18 | 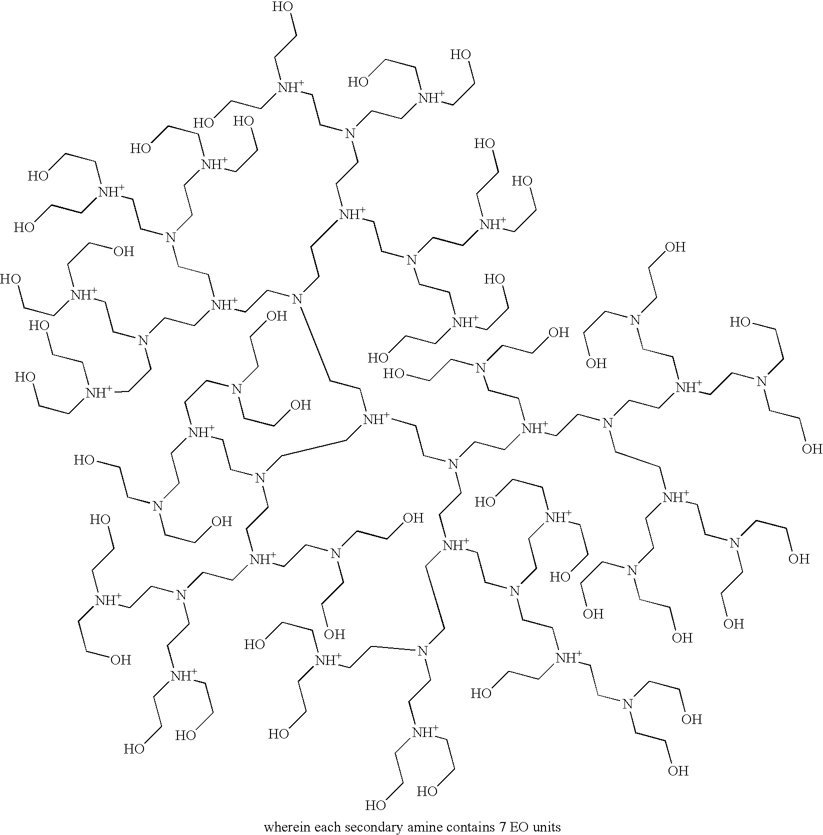 |

| | | | | | | | |
|---|---|---|---|---|---|---|---|
| 4 | 3 | 0.709 | 0.549 | −2.08 | 23.47 | 51.2 | 116 |

| | |
|---|---|
| Structure 19 | 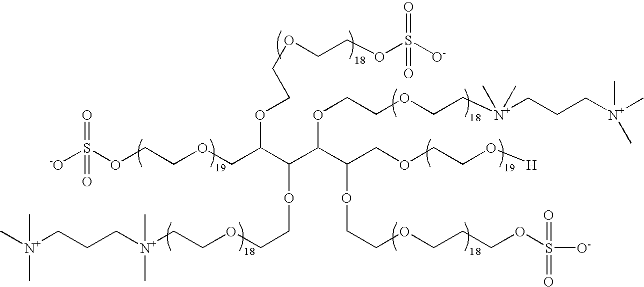 |

| | | | | | | | | |
|---|---|---|---|---|---|---|---|---|
| Poly168 | 6 | 3 | 1.044 | 0.539 | —2.08 | 23.47 | 200.1 | 157 |

| | |
|---|---|
| Structure 20 | 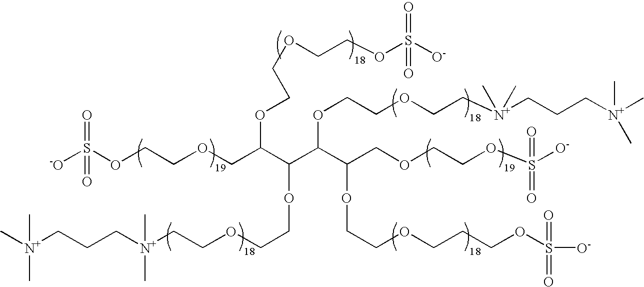 |

| | | | | | | | |
|---|---|---|---|---|---|---|---|
| 2 | 4 | 0.158 | 0.325 | ND | ND | 61.76866 | ND |

| | |
|---|---|
| Structure 21 | 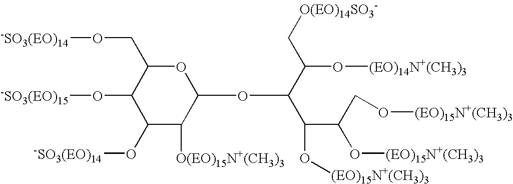 |

| | | | | | | | |
|---|---|---|---|---|---|---|---|
| 4 | 0 | 0.551 | 0.000 | −3.174 | 24.66 | 61.8 | 56.9 |

| | |
|---|---|
| Structure 22 | 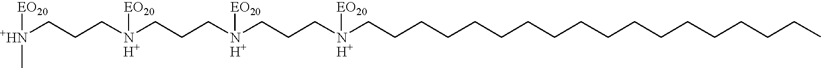 |

Polyimine Polymers

A preferred example of a surfactant boosting polymer is a polyimine polymer exemplified in formula (II) below: 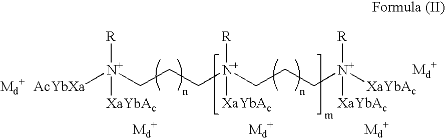
Wherein R of formula (II) is hydrogen, C₆-C₂₂ aromatic and/or C₁-C₂₂ linear or C₄-C₂₂ branched alkyl, C₂-C₂₂ alkoxy, and mixtures of thereof. If R is selected as being branched, the branch may comprise from 1 to 4 carbon atoms. X formula (II) is selected from group of hydrogen, C₁-C₂₀ linear or C₄-C₂₀ branched alkylene, C₂-C₅ linear or C₄-C₅ branched oxyalkylene and mixtures of thereof. When X is selected as being branched, the branch may comprise from 1 to 4 carbon atoms. Index a formula (II) is from 0-50; wherein when a formula (II) is 0, b or c formula (II) must be greater than 0. Y formula (II) is selected from group of hydrogen, Cl-C₂₀ linear or C₄-C₂₀ branched alkylene, C₂-C₅ linear or C₄-C₅ branched oxyalkylene, and mixtures of thereof. If Y is selected as being branched, the branch may comprise from 1 to 4 carbon atoms. The index b formula (II) is a number from 0 to 50; wherein when b formula (II) is 1 or greater, X formula (II) is not hydrogen. A formula (II) is a capping group selected from the sulfate, sulfonate, carboxylate, phosphate, and mixtures thereof. The index c formula (II) is 0 or 1; wherein when c formula (II) is 1, X and Y formula (II) are not hydrogen. The index n formula (II) is from 0 to 16. The index m formula (II) is from 0 to 5. M formula (II) is a water soluble cation such as hydrogen, sodium, calcium, and mixtures thereof. The index d formula (II) is 0 or 1; wherein when c formula (II) is 1, d formula (II) is 1. See also U.S. Pat. No. 4,659,802; U.S. Pat. No. 4,664,848; U.S. Pat. No. 4,661,288; U.S. Pat. No. 6,087,316; and WO 01/05874. A nonlimiting example of a preferred polyimine polymer is shown in structures 6-15 above.
Alkoxylated Monoamine

Another preferred polymer of the present invention includes alkoxylated monoamines having formulae (III) and (IV). 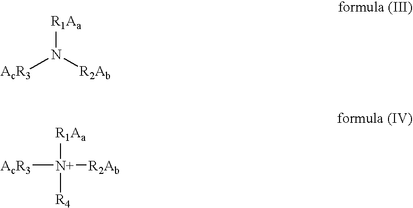
Where R₁, R₂, R₃ and R₄ of formulae (III) and (IV) arejindependently selected from group of hydrogen, aliphatic, aromatic, preferably alkyl C₂-C₂₀, aromatic C₆-C₁₈, and single and/or repeating block units of linear or branched alkylene (C₁-C₂₀), linear or branched oxyalkylene (C₂-C₅) and mixtures of thereof; when selected as branched, the branch comprise from 1 to 4 carbon atoms; preferably R₁, R₂, R₃ and R₄ are independently selected to be C₂-₃ linear oxyalklene having an average degree of alkoxylation from about 1 to about 30. Aₐ, A_{b}, A_{c} of formulae (III) and (IV) are capping groups independently selected from the hydrogen, hydroxy, nitro, amino, imido, sulpho, carbo, phospho, sulfated, sulfonated, carboxylated, phosphated, and mixtures thereof.
Branched Polyaminoamines

A preferred example of a surfactant boosting polymer is exemplified in structural formula (V) below: 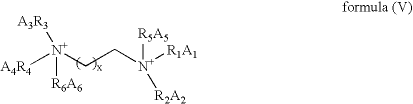
where x of formula (V) can be from 1 to 12, more preferably from 1 to 8, more preferably from 1 to 6 and even more preferably from 1 to 4, R₅ and R₆ of formula (V) may not be present (at which case N is neutral), and/or may be independently chosen from group of H, aliphatic C₁-C₆, alkylene C₂-C₆, arylene, or alkylarylene, R₁, R₂, R₃, and R₄ of formula (V) are independently chosen from the group of H, OH, aliphatic C₁-C₆, alkylene C₂-C₆, arylene, or alkylarylene, preferably at least one or more block of polyoxyalkylene C₂-C₅, and single and/or repeating block units of linear or branched alkylene (C₁-₂₀), linear or branched oxyalkylene (C₂-C₅) and mixtures of thereof. A₁, A₂, A₃, A₄, A₅, and A₆ of formula (V) are capping groups independently selected from hydrogen, hydroxy, sulfate, sulfonate, carboxylate, phosphate, and mixtures thereof. If R₁, R₂, R₃, or R₄ are N(CH₂)ₓCH₂, than it represent continuation of this structure by branching. See also U.S. Pat. No. 4,597,898; U.S. Pat. No. 4,891,160; U.S. Pat. No. 5,565,145; and U.S. Pat. No. 6,075,000. A preferred example of a surfactant boosting polymer selected from branched polyaminoamines is exemplified in structures 18 and 19 above. Additionally, the ethoxy moieties of structure 17 can also comprise other alkoxy moieties such as propoxy and butoxy. The average degree of alkoxylation can also be more than 7, preferably from about 7 to about 40.
Modified Polyol Based Ethoxylated Polymers

Another preferred example of a polymer suitable for use in the present invention includes polyol compounds compriseing at least three hydroxy moieties, preferably more than three hydroxy moieties. Most preferably six or more hydroxy moieties. At least one of the hydroxy moieties further comprising a alkoxy moiety, the alkoxy moiety is selected from the group consisting of ethoxy (EO), propoxy (PO), butoxy (BO) and mixtures thereof preferably ethoxy and propoxy moieties, more preferably ethoxy moieties. The average degree of alkoxylation is from about 1 to about 100, preferably from about 4 to about 60, more preferably from about 10 to about 40. Alkoxylation is preferably block alkoxylation.

The polyol compounds useful in the present invention further have at least one of the alkoxy moieties comprising at least one anionic capping unit. Further modifications of the compound may occur, but one anionic capping unit must be present in the compound of the present invention. One embodiment comprises more than one hydroxy moiety further comprising an alkoxy moiety having an anionic capping unit. For example formula (VI): 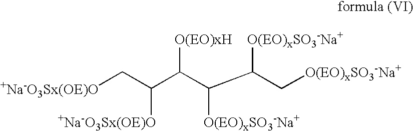
wherein x of formula (VI) is from about 1 to about 100, preferably from about 10 to about 40.

Suitable anionic capping unit include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, ethylene carboxylate, carbonates, mellitic, pyromellitic, sulfophenol, sulfocatechol, disulfocatechol, tartrate, citrate, acrylate, methacrylate, poly acrylate, poly acrylate-maleate copolymer, and mixtures thereof. Preferably the anionic capping units are sulfate, sulfosuccinate, succinate, maleate, sulfonate, methylene carboxylate and ethylene carboxylate. Suitable polyol compounds for starting materials for use in the present invention include maltitol, sucrose, xylitol, glycerol, pentaerythitol, glucose, maltose, matotriose, maltodextrin, maltopentose, maltohexose, isomaltulose, sorbitol, poly vinyl alcohol, partially hydrolyzed polyvinylacetate, xylan reduced maltotriose, reduced maltodextrins, polyethylene glycol, polypropylene glycol, polyglycerol, diglycerol ether and mixtures thereof. Preferably the polyol compound is sorbitol, maltitol, sucrose, xylan, polyethylene glycol, polypropylene glycol and mixtures thereof. Preferably sorbitol, maltitol, sucrose, xylan, and mixtures thereof.

Modification of the polyol compounds is dependant upon the desired formulability and performance requirements. Modification can include incorporating an anionic, cationic, or zwitterionic charges to the polyol compounds.

In one embodiment of the present invention, at least one hydroxy moiety comprises an alkoxy moiety, wherein at least one alkoxy moiety further comprises at least one anionic capping unit.

In another embodiment of the present invention, at least one hydroxy moiety comprises an alkoxy moiety, wherein the alkoxy moiety further comprises more than one anionic capping unit, wherein at least one anionic capping unit, but less than all anionic capping units, is then selectively substituted by an amine capping unit. The amine capping unit is selected from a primary amine containing capping unit, a secondary amine containing capping unit, a tertiary amine containing capping unit, and mixtures thereof.

The polyol compounds useful in the present invention further have at least one of the alkoxy moieties comprising at least one amine capping unit. Further modifications of the compound may occur, but one amine capping unit must be present in the compound of the present invention. One embodiment comprises more than one hydroxy moiety further comprising an alkoxy moiety having an amine capping unit.

In another embodiment of the present invention, at least one of nitrogens in the amine capping unit is quaternized. As used herein “quaternized” means that the amine capping unit is given a positive charge through quaternization or protonization of the amine capping unit. For example, bis-DMAPA contains three nitrogens, only one of the nitrogens need be quaternized. However, it is preferred to have all nitrogens quaternized on any given amine capping unit.

Suitable primary amines for the primary amine containing capping unit include monoamines, diamine, triamine, polyamines, and mixtures thereof. Suitable secondary amines for the secondary amine containing capping unit include monoamines, diamine, triamine, polyamines, and mixtures thereof. Suitable tertiary amines for the tertiary amine containing capping unit include monoamines, diamine, triamine, polyamines, and mixtures thereof.

Suitable monoamines, diamines, triamines or polyamines for use in the present invention include ammonia, methyl amine, dimethylamine, ethylene diamine, dimethylaminopropylamine, bis dimethylaminopropylamine (bis DMAPA), hexemethylene diamine, benzylamine, isoquinoline, ethylamine, diethylamine, dodecylamine, tallow triethylenediamine, mono substituted monoamine, monosubstituted diamine, monosubstituted polyamine, disubstituted monoamine, disubstiuted diamine, disubstituted polyamine, trisubstituted triamine, tri substituted polyamine, multisubstituted polyamine comprising more than three substitutions provided at least one nitrogen contains a hydrogen, and mixtures thereof.

In another embodiment of the present invention, at least one of nitrogens in the amine capping unit is quaternized. As used herein “quaternized” means that the amine capping unit is given a positive charge through quaternization or protonization of the amine capping unit. For example, bis-DMAPA contains three nitrogens, only one of the nitrogens need be quaternized. However, it is preferred to have all nitrogens quaternized on any given amine capping unit.

The modification may be combined depending upon the desired formulability and performance requirements. Specific, non-limiting examples of preferred modified polyol compounds of the present invention include structures 19-21 above.

Hydrophobic Polyamine Ethoxylate Polymers

Materials included in the invention of the present application include-hydrophobic polyamine ethoxylate polymers characterized by comprising a general formula (VI): 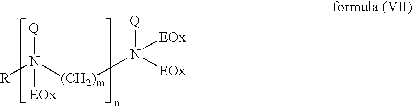
R of formula (I) is a linear or branched C₁-C₂₂ alkyl, a linear or branched C₁-C₂₂ alkoxyl, linear or branched C₁-C₂₂ acyl, and mixtures thereof; if R is selected as being branched, the branch may comprise from 1 to 4 carbon atoms; preferably R of formula (I) is a linear C₁₂ to C₁₈ alkyl. The alkyl, alkoxyl, and acyl may be saturated or unsaturated, preferably saturated. The n index of formula (I) is from about 2 to about 9, preferably from about 2 to about 5, most preferably 3. Without being limited by a theory, it is believed that the hydrophobic tail R of formula (I) provides removal of hydrophobic stains such as oil. It is further believed that the hydrophobic tail R of formula (I) provides some prevention of the formation of larger ordered aggregates of an anionic surfactant in the presence of free hardness.

Q of formula (I) is independently selected from an electron pair, hydrogen, methyl, ethyl, and mixtures thereof. If the formulator desires a neutral backbone of the hydrophobic polyamine ethoxylate, Q of formula (I) should be selected to be an electron pair or a hydrogen. Should the formulator desire a quaternized backbone of the hydrophobic polyamine ethoxylate, at least on Q of formula (I) should be chosen from methyl, ethyl, preferably methylThe m index of formula (I) is from 2 to 6, preferably 3. The index x of formula (I) isindependently selected to average from about 1 to about 70 ethoxy units, preferably an average from about 20 to about 70, preferably about 30 to about 50, for polymers containing nonquaternized nitrogens; preferably from about 1 to about 10 for polymers containing quaternized nitrogens.

The ethoxy units of the hydrophobic polyamine ethoxylate may be further modified by independently adding an anionic capping unit to any or all ethoxy units. Suitable anionic capping units include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, carbonates, mellitic, pyromellitic, citrate, acrylate, methacrylate, and mixtures thereof. Preferably the anionic capping unit is a sulfate.

In another embodiment of the present invention, the nitrogens of the hydrophobic polyamine ethoxylate are given a positive charge through quaternization. As used herein “quaternization” means quaternization or protonization of the nitrogen to give a positive charge to the nitrogens of the hydrophobic polyamine ethoxylate.

The tuning or modification may be combined depending upon the desired formulability and performance requirements. Specific, non-limiting examples of preferred hydrophobic polyamine ethoxylate of the present invention include structure 22 above and formula (VIII): 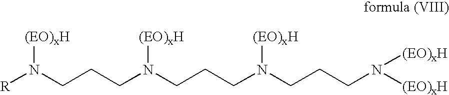
wherein R of formula (VIII) is a linear or branched C₁₂-C₁₆ alkyl, and mixtures thereof; if R is selected as being branched, the branch may have from 1 to 4 carbon atoms; x of formula (VIII) is from about 20 to about 70.

Table II below lists several not-limiting examples of designed materials with desired parameters and with predicted SB₅₀.

TABLE II

| | | | | | | | SB₅₀ |
|---|---|---|---|---|---|---|---|
| Name | COPC | ESO4 | CD₂ | CD₆ | V_{χP}⁵ | SH_{Bint10} | predicted |
| Pol 1 | 11.911 | 2.646 | 0.117 | 1.097 | −0.706 | 15.792 | 2.0 |
| Pol 2 | 11.424 | 4.404 | 1.613 | 0.135 | −0.571 | 7.364 | 5.0 |
| Pol 3 | 6.956 | 5.943 | 1.101 | 0.021 | −0.790 | 9.530 | 10.3 |
| Pol 4 | 7.948 | 5.824 | 0.150 | 1.060 | −5.684 | 7.384 | 20.0 |
| Pol 5 | 7.503 | 4.522 | 1.375 | 0.386 | −1.895 | 5.260 | 49.4 |
| Pol 6 | 4.297 | 3.483 | 0.434 | 0.514 | −2.659 | 21.139 | 99.9 |
| Pol 7 | 7.011 | 5.330 | 1.502 | 0.688 | −2.300 | 16.743 | 154.1 |
| Pol 8 | 9.500 | 4.993 | 1.476 | 1.626 | −1.820 | 14.550 | 206.5 |
| Pol 9 | 3.806 | 4.205 | 0.824 | 0.216 | −5.455 | 24.959 | 301.9 |
| Pol 10 | 10.508 | 1.875 | 1.712 | 1.628 | −0.629 | 4.857 | 302.0 |
| Pol 11 | 1.349 | 3.087 | 0.280 | 0.379 | −4.106 | 17.207 | 402.2 |
| Pol 12 | 4.249 | 3.483 | 0.664 | 1.307 | −0.872 | 15.503 | 403.0 |

The designed polymers of Table II can then be matched with suitable functional groups for the main chain and side chain chemical structures through Correlation (I). As one of skilled in the art determines the suitable portions of the main chain and side chain desired, a newly designed polymer results.

By contrast, Correlation (I) can also be used to determine structures that would not be suitable to obtain the desired surfactant boosting properties. Table III below lists several not-limiting examples of designed materials molecular descriptors with predicted SB₅₀ not included in the present invention.

TABLE III

| | | | | | | | SB₅₀ |
|---|---|---|---|---|---|---|---|
| Name | COPC | ESO4 | CD₂ | CD₆ | V_{χP}⁵ | SH_{Bint10} | predicted |
| Pol 37 | 4.670 | 0.623 | 1.007 | 0.210 | −4.399 | 15.926 | 501.8 |
| Pol 38 | 4.674 | 3.376 | 1.519 | 0.854 | −0.663 | 7.099 | 709.4 |
| Pol 39 | 1.368 | 3.172 | 0.760 | 1.424 | −1.402 | 7.710 | 3009.7 |

Cleaning Comipositions

The present invention further relates to a cleaning composition comprising the surfactant boosting polymer of the present invention. The cleaning compositions can be in any conventional form, namely, in the form of a liquid, powder, granules, agglomerate, paste, tablet, pouches, bar, gel, types delivered in dual-compartment containers, spray or foam detergents, premoistened wipes (i.e., the cleaning composition ‘in combination with a nonwoven material such as that discussed in U.S. Pat. No. 6,121,165, Mackey, et al.), dry wipes (i.e., the cleaning composition in combination with a nonwoven materials, such as that discussed in U.S. Pat. No. 5,980,931, Fowler, et al.) activated with water by a consumer, and other homogeneous or multiphase consumer cleaning product forms.

In addition to cleaning compositions, the compounds of the present invention may be also suitable for use or incorporation into industrial cleaners (i.e. floor cleaners). Often these cleaning compositions will additionally comprise surfactants and other cleaning adjunct ingredients, discussed in more detail below. In one embodiment, the cleaning composition of the present invention is a liquid or solid laundry detergent composition.

In another embodiment, the cleaning composition of the present invention is a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate.

In another embodiment the cleaning composition is a liquid dish cleaning composition, such as liquid hand dishwashing compositions, solid automatic dishwashing cleaning compositions, liquid automatic dishwashing cleaning compositions, and tab/unit does forms of automatic dishwashing cleaning compositions.

The cleaning composition may also be utilized in car care compositions, for cleaning various surfaces such as hard wood, tile, ceramic, plastic, leather, metal, glass. This cleaning composition could be also designed to be used in a personal care composition such as shampoo composition, body wash, liquid or solid soap and other cleaning composition in which surfactant comes into contact with free hardness and in all compositions that require hardness tolerant surfactant system, such as oil drilling compositions.

Surfactant Boosting Polymer

The surfactant boosting polymer suitable for use in the present invention is present in the cleaning compositions from about 0.001% to about 30% by weight of the cleaning composition; preferably from about 0.05% to about 10%, more preferably from about 0.1% to about 5% by weight of the cleaning composition.

Surfactants—Surfactant that may be used for the present invention may comprise a surfactant or surfactant system comprising surfactants selected from nonionic, anionic, cationic surfactants, ampholytic, zwitterionic, semi-polar nonionic surfactants, other adjuncts such as alkyl alcohols, or mixtures thereof.

The cleaning composition of the present invention further comprises from about 0.1% to about 20%, preferably from about 0.2% to about 10%, more preferably from about 0.2% to about 5% by weight of the cleaning composition of a surfactant system having one or more surfactants.

Anionic Surfactants

Nonlimiting examples of anionic surfactants useful herein include: C₈-C₁₈ alkyl benzene sulfonates (LAS); C₁₀-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS).

Cleaning Adiunct Materials

In general, a cleaning adjunct is any material required to transform a cleaning composition containing only the minimum essential ingredients into a cleaning composition useful for laundry, hard surface, personal care, consumer, commercial and/or industrial cleaning purposes. In certain embodiments, cleaning adjuncts are easily recognizable to those of skill in the art as being absolutely characteristic of cleaning products, especially of cleaning products intended for direct use by a consumer in a domestic environment.

The precise nature of these additional components, and levels of incorporation thereof, will depend on the physical form of the cleaning composition and the nature of the cleaning operation for which it is to be used.

The cleaning adjunct ingredients if used with bleach should have good stability therewith. Certain embodiments of cleaning compositions herein should be boron-free and/or phosphate-free as required by legislation. Levels of cleaning adjuncts are from about 0.00001% to about 99.9%, by weight of the cleaning compositions. Use levels of the overall cleaning compositions can vary widely depending on the intended application, ranging for example from a few ppm in solution to so-called “direct application” of the neat cleaning composition to the surface to be cleaned.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove as part of the essential component of the cleaning compositions of the present invention. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

Enzymes

The cleaning composition can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, 1-glucanases, arabinosidases, hyaluronidase, chondroitinase, laccase, and known amylases, or mixtures thereof. A preferred combination is a cleaning composition having a cocktail of conventional applicable enzymes like protease, lipase, cutinase and/or cellulase in conjunction with the amylase of the present invention.

Methods

The present invention includes a method for cleaning a surface or fabric. Such method includes the steps of contacting a surfactant boosting polymer of the present invention or an embodiment of the cleaning composition comprising the surfactant boosting polymer of the present invention, in neat form or diluted in a wash liquor, with at least a portion of a surface or fabric then optionally rinsing such surface or fabric. Preferably the surface or fabric is subjected to a washing step prior to the aforementioned optional rinsing step. For purposes of the present invention, washing includes but is not limited to, scrubbing, and mechanical agitation.

As will be appreciated by one skilled in the art, the cleaning compositions of the present invention are ideally suited for use in home care (hard surface cleaning compositions), personal care and/or laundry applications. Accordingly, the present invention includes a method for cleaning a surface and/or laundering a fabric. The method comprises the steps of contacting a surface and/or fabric to be cleaned/laundered with the surfactant boosting polymer or a cleaning composition comprising the surfactant boosting polymer. The surface may comprise most any hard surface being found in a typical home such as hard wood, tile, ceramic, plastic, leather, metal, glass, or may consist of a cleaning surfaces in a personal care product such as hair and skin. The surface may also include dishes, glasses, and other cooking surfaces. The fabric may comprise most any fabric capable of being laundered in normal consumer use conditions.

The cleaning composition solution pH is chosen to be the most complimentary to a surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution.

The water temperatures preferably range from about 5° C. to about 100° C.

For use in laundry cleaning compositions, the compositions are preferably employed at concentrations from about 200 ppm to about 10000 ppm in solution (or wash liquor). The water temperatures preferably range from about 5° C. to about 60° C. The water to fabric ratio is preferably from about 1:1 to about 20:1.

As will be appreciated by one skilled in the art, the cleaning compositions of the present invention are also suited for use in personal cleaning care applications. Accordingly, the present invention includes a method for cleaning skin or hair. The method comprises the steps of contacting a skin / hair to be cleaned with a cleaning solution or nonwoven substrate impregnated with an embodiment of Applicants’ cleaning composition. The method of use of the nonwoven substrate when contacting skin and hair may be by the hand of a user or by the use of an implement to which the nonwoven substrate attaches.

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of preventing large ordered aggregates of at least one surfactant comprising the use of a minimum molar amount of a polymer comprising solubility of at least 10 ppm at 20° C., a weight average molecular weight from about 1500 to 200,000 daltons; and comprising a main chain and at least one side chain extending from the main chain and the side chain comprising a terminal end such that the terminal end terminates the side chain; at least one side chain comprising an alkoxy moiety, wherein the polymer has an SB₅₀ value of 430 or less when in the presence of the surfactant and water having at least 2 gpg free ions.

2. A method of increasing the level of available surfactant of at least one surfactant comprising the use of a minimum molar amount of a polymer comprising solubility of at least 10 ppm at 20° C., a weight average molecular weight from about 1500 to 200,000 daltons; and comprising a main chain and at least one side chain extending from the main chain and the side chain comprising a terminal end such that the terminal end terminates the side chain; at least one side chain comprising an alkoxy moiety, wherein the polymer has an SB₅₀ value of 430 or less when in the presence of the surfactant and water having at least 2 gpg free ions.
